(19) United States
(12) Patent Application Publication
(10) Pub. No.: US 2023/0168498 A1
(43) Pub. Date: Jun. 1, 2023

(54) POSITIONING SUPPORT APPARATUS, POSITIONING SUPPORT METHOD, AND PROGRAM

(71) Applicant: NIPPON TELEGRAPH AND TELEPHONE CORPORATION, Tokyo (JP)

(72) Inventors: Ryohei SAIJO, Musashino-shi, Tokyo (JP); Shinichiro EITOKU, Musashino-shi, Tokyo (JP); Takuya GODA, Musashino-shi, Tokyo (JP); Yuichi MAKI, Musashino-shi, Tokyo (JP); Takahiro KUSABUKA, Musashino-shi, Tokyo (JP)

(73) Assignee: NIPPON TELEGRAPH AND TELEPHONE CORPORATION, Tokyo (JP)

(21) Appl. No.: 17/922,769

(22) PCT Filed: May 15, 2020
(86) PCT No.: PCT/JP2020/019555

§ 371 Date: Nov. 1, 2022

(51) Int. Cl. G02B 27/01; G06T 19/00

(52) U.S. Cl. CPC G02B 27/01; G06T 19/006; G02B 2027/014

(57) ABSTRACT

A positioning assistance device that assists positioning between a content displayed on a display and an object transparently observed through the display is as follows. The positioning assistance device includes: a state calculation unit configured to calculate a supported state of the display relative to the object; an adjustment amount calculation unit configured to calculate, for the supported state, an adjustment amount related to a positioning operation for setting an appropriate positional relation between the content and the object; and a presentation information generation unit configured to generate and output presentation information including the adjustment amount. The adjustment amount calculation unit calculates the adjustment amount by using record data of a positioning operation performed by a user of the display in response to the presentation information output in advance.

### TECHNICAL FIELD

Embodiments of the present invention relate to a positioning assistance device, a positioning assistance method, and a program that assist positioning between an augmented-reality content and an object.

### BACKGROUND ART

Recently, an augmented reality (AR) technology that superimposes and displays digital information, such as a virtual object, in a space in reality has attracted attention. A user can experience an augmented reality in which digital information (AR content) is superimposed in a reality space through, for example, a portable display device.

A technology that superimpose navigation information in eyesight of a pedestrian by using a glass-type device is disclosed as an exemplary application using AR contents (refer to Non-Patent Literature 1, for example).

### CITATION LIST

### Non-Patent Literature

Non-Patent Literature 1: Ryota Yano et al., “A Navigation System for an outdoor pedestrian based on Landmark Recognition by Glass-type Wearable Devices”, Multimedia, Distributed, Cooperative, and Mobile (DICOMO2016) Symposium 2016, pp. 419 to 427, July, 2016

### SUMMARY OF THE INVENTION

### Technical Problem

An exemplary system configured to superimpose and display digital information in a reality space is achieved by using an information presentation terminal including a transmissive display and a camera. When a user grasps the information presentation terminal and holds its display over an object in a reality space, an AR content (hereinafter also simply referred to as “content”) based on video data of an object, an image of which is captured by the camera is displayed on the display. Accordingly, the user can visually recognize the content on the display while observing the object through the display.

The user needs to adjust the position and angle of the terminal to perform positioning between the object observed through the display and the content. In a conventional system, for example, presentation information indicating a superimposition target object is used to prompt the user to perform such a positioning operation.

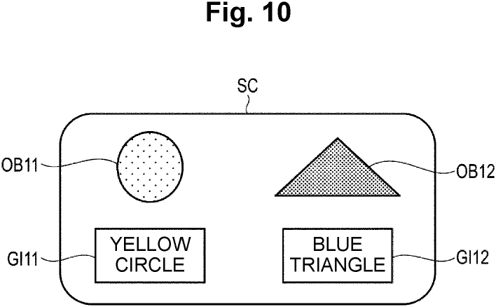

FIG. 10 illustrates exemplary conventional presentation information. In FIG. 10, objects OB11 and OB12 are observed by a user through a display screen SC of an information presentation terminal, and presentation information GIll and GI12 are displayed on the display screen SC. The presentation information GI11 includes text information “yellow circle”, corresponds to OB11 as a target object, and guides superimposition of GI11 on OB11. Similarly, the presentation information GI12 includes text information “blue triangle”, corresponds to OB12 as a target object, and guides superimposition of GI12 on OB12. Note that color information in FIG. 10 is expressed by shading.

In this manner, in a conventional system, each target object is clearly indicated in presentation information to prompt positioning for holding an information presentation terminal toward a place that a content provider expects to be watched. In such a conventional system, presentation information defined in advance is continuously used and which specific positioning operation is to be performed depends on a user, and thus it is not easy to appropriately achieve guiding to a positional relation intended between a content and an object by the provider of the content.

The present invention has been made with a focus on the above-described situation and aims to provide a technology of efficiently assisting positioning that achieves an appropriate positional relation between a content and an object.

### Means for Solving the Problem

A first aspect of the present invention for solving the above-described problem relates to a positioning assistance device that assists positioning between a content displayed on a display and an object transparently observed through the display. The positioning assistance device includes: a state calculation unit configured to calculate a supported state of the display relative to the object; an adjustment amount calculation unit configured to calculate, for the supported state, an adjustment amount related to a positioning operation for setting an appropriate positional relation between the content and the object; and a presentation information generation unit configured to generate and output presentation information including the adjustment amount. The adjustment amount calculation unit calculates the adjustment amount by using record data of a positioning operation performed by a user of the display in response to the presentation information output in advance.

### Effects of the Invention

According to a first aspect of the present invention, information that assists positioning between a content and an object is presented to a user of a display. For this, an adjustment amount is calculated by using record data of a positioning operation performed by the user in response to presentation information output in advance and is included in the presentation information. Accordingly, information to be presented to the user can be generated with taken into consideration what positioning operation tends to be actually performed, and more efficient guiding can be performed.

Thus, according to the first aspect of the present invention, it is possible to provide a technology that efficiently assists positioning for setting an appropriate positional relation between a content and an object.

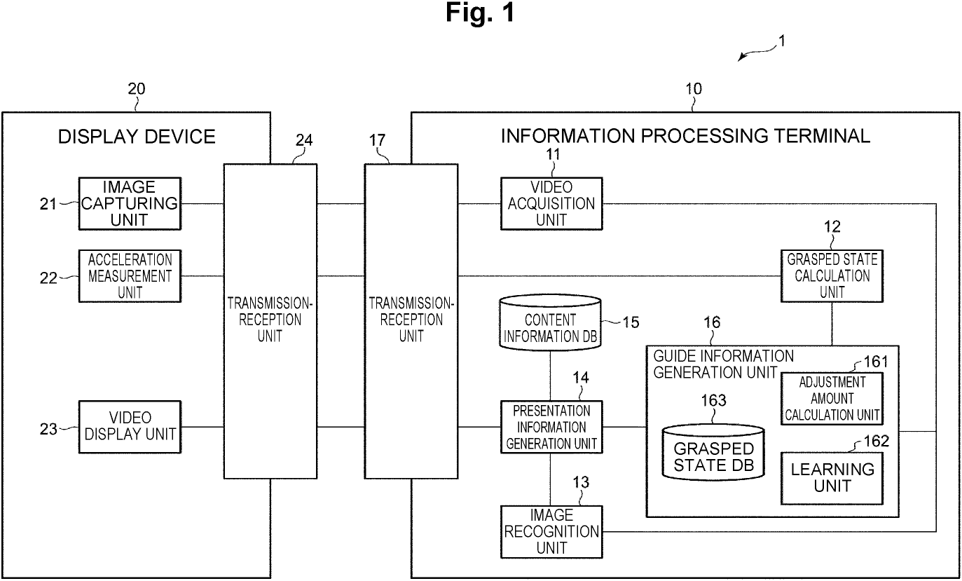

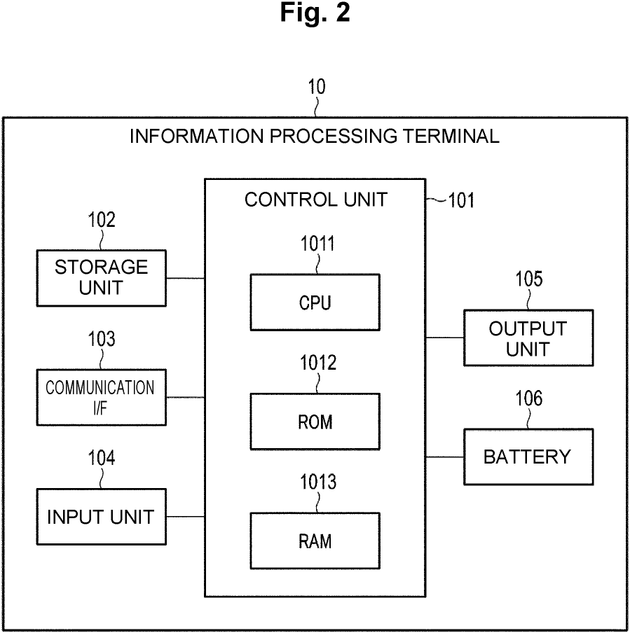

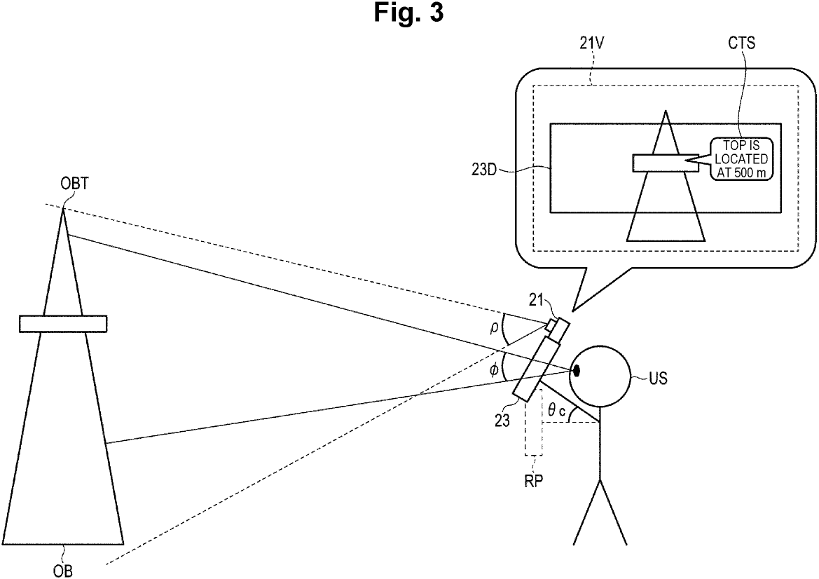

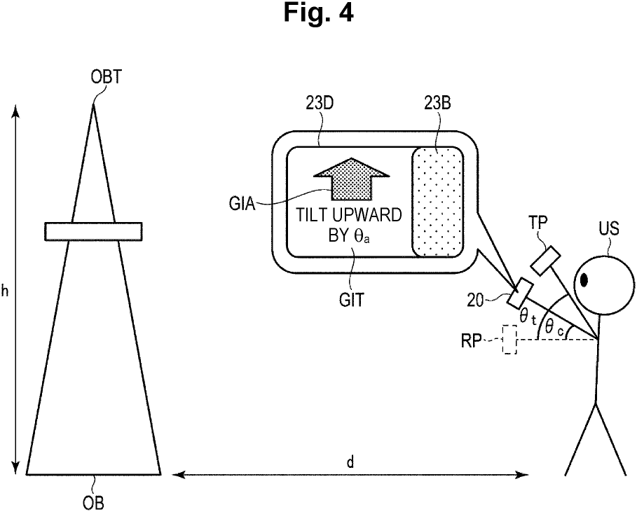

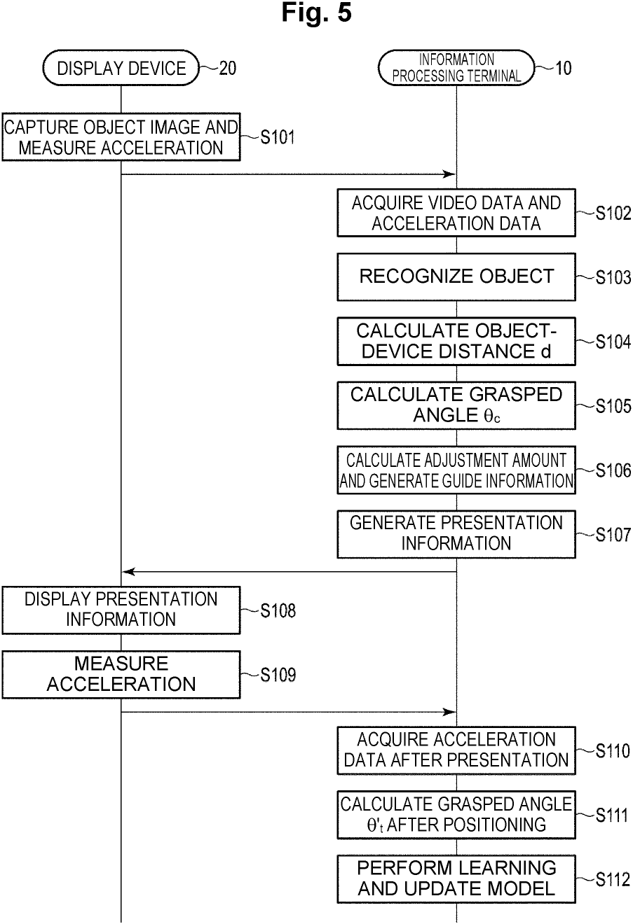

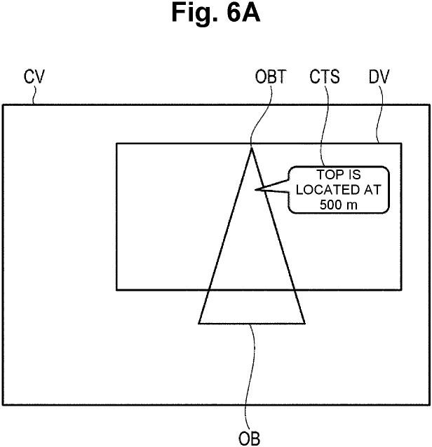

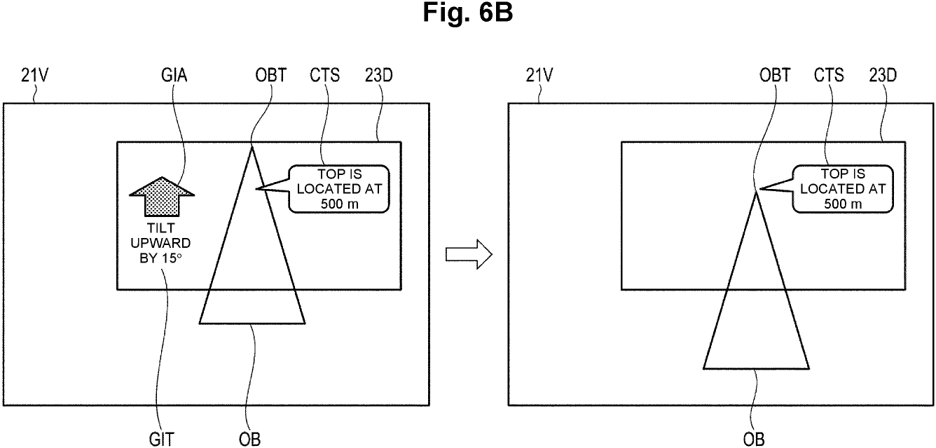

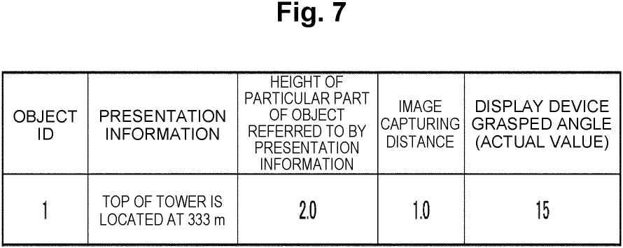

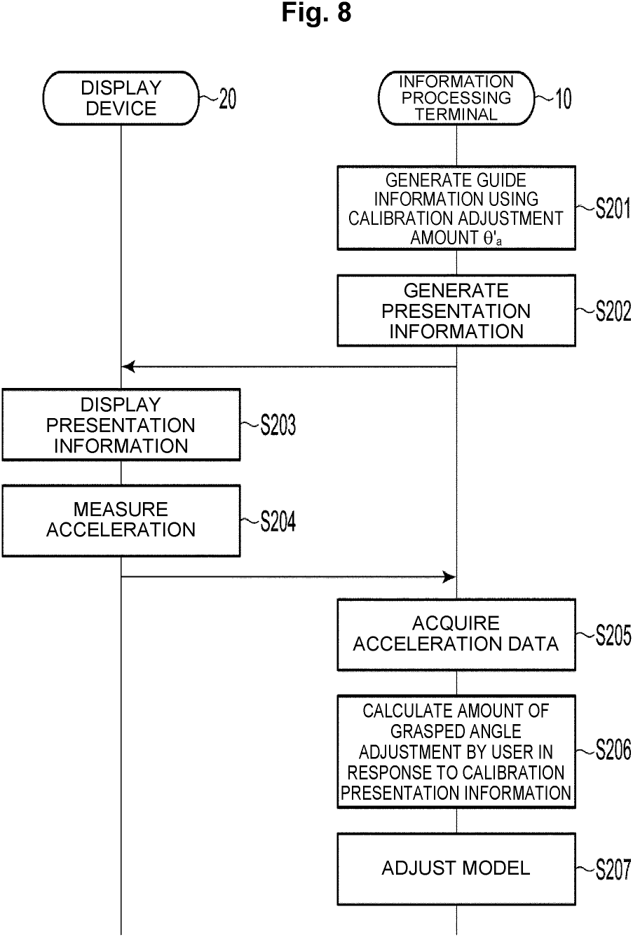

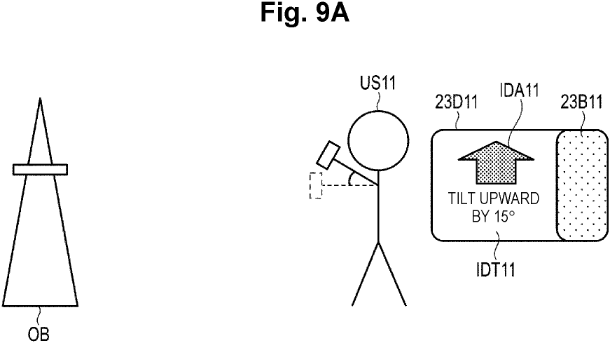

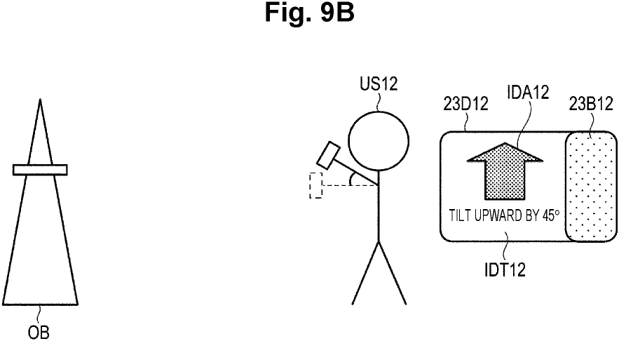

### BRIEF DESCRIPTION OF DRAWINGS

[FIG. 1] FIG. 1 is a diagram illustrating an entire functional configuration of a system including a positioning assistance device according to an embodiment of the present invention.

[FIG. 2] FIG. 2 is a block diagram illustrating a hardware configuration of the positioning assistance device according to the embodiment of the present invention.

[FIG. 3] FIG. 3 is a schematic diagram illustrating the relation between an image capturing range and an observation range of a user in the system illustrated in FIG. 1.

[FIG. 4] FIG. 4 is a diagram for description of symbols or reference signs related to operation of the system illustrated in FIG. 1.

[FIG. 5] FIG. 5 is a diagram illustrating an exemplary processing process of guide information generation by the system illustrated in FIG. 1.

[FIG. 6A] FIG. 6A is a diagram illustrating exemplary display of conventional presentation information.

[FIG. 6B] FIG. 6B is a diagram illustrating exemplary display of presentation information in the system illustrated in FIG. 1.

[FIG. 7] FIG. 7 is a diagram illustrating exemplary record data used in the system illustrated in FIG. 1.

[FIG. 8] FIG. 8 is a diagram illustrating an exemplary processing process of calibration by the system illustrated in FIG. 1.

[FIG. 9A] FIG. 9A is a diagram illustrating a first exemplary guide information correction image.

[FIG. 9B] FIG. 9B is a diagram illustrating a second exemplary guide information correction image.

[FIG. 10] FIG. 10 is a diagram illustrating an example of the conventional presentation information.

### DESCRIPTION OF EMBODIMENTS

Embodiments of the present invention will be described below with reference to the accompanying drawings. Note that, in the following description, an element identical or similar to an already described element is denoted by an identical or similar reference sign, and duplicate description thereof is basically omitted. For example, when a plurality of identical or similar elements are provided, a common reference sign may be used to describe each element without distinction, and a branch number may be used in addition to the common reference sign to describe each element in distinction.

### Embodiment

### Configuration

FIG. 1 is a diagram illustrating an example of the entire configuration of a positioning assistance system including a positioning assistance device according to an embodiment of the present invention.

A positioning assistance system 1 includes an information processing terminal 10 as a positioning assistance device, and a display device 20.

The display device 20 is, for example, a portable device including a transparent display. A user can grasp the display device 20 with, for example, a hand and browse contents related to a captured object while transparently observing the object in a reality space. However, during browsing, the user does not necessarily need to keep grasping the display device 20 with a hand, but the display device 20 only needs to be appropriately supported. Thus, “grasping” in the following description is not necessarily intended to limit usage to grasping with a hand but is expressed so for the purpose of description. In the description, “grasping” is used in a manner replaceable with “support”. In addition, a “content” in the description means a general content of augmented reality implemented on a display and is used in a manner replaceable with “digital information”.

The display device 20 includes an image capturing unit 21, an acceleration measurement unit 22, a video display unit 23, and a transmission-reception unit 24.

The image capturing unit 21 has a function to capture an image of an object in a reality space and generate video data or image data. Note that “video data” is used in the following description for the purpose of description but may be image (still image) data.

The acceleration measurement unit 22 has a function such as an acceleration sensor to measure acceleration applied to the display device 20 and output acceleration data.

The video display unit 23 includes, for example, a transparent display and has a function to enable transparent observation of an object and display a content.

The transmission-reception unit 24 includes, for example, a Bluetooth (registered trademark) interface and has a function to enable data transmission to and reception from the information processing terminal 10.

The information processing terminal 10 is an exemplary positioning assistance device according to the embodiment. The information processing terminal 10 has a function to perform such as image recognition and presentation information generation processing based on video data forwarded from the display device 20 and transmit a result of the processing to the display device 20. The information processing terminal 10 may be a dedicated terminal for implementing the above-described function or may be a general-purpose terminal such as a smartphone, a tablet terminal, or a personal computer on which dedicated application software is installed.

The information processing terminal 10 includes a video acquisition unit 11, a grasped state calculation unit 12, an image recognition unit 13, a presentation information generation unit 14, a content information database (DB) 15, a guide information generation unit 16, and a transmission-reception unit 17.

The video acquisition unit 11 has a function to acquire video data obtained through image capturing by the image capturing unit 21.

The grasped state calculation unit 12, as a state calculation unit configured to calculate a supported state, has a function to calculate a value representing a state in which the display device 20 is grasped (supported) by a user. In the embodiment, the grasped state calculation unit 12 calculates an angle (hereinafter referred to as “grasped angle”) at which the display device 20 is grasped by a user. For example, the grasped state calculation unit 12 acquires acceleration data measured by the acceleration measurement unit 22 and calculates, based on gravitational acceleration applied to the display device 20, the angle at which the display device 20 is grasped by a user.

The image recognition unit 13 has a function to recognize an object from video data obtained through image capturing by the image capturing unit 21. The image recognition unit 13 recognizes an object through, for example, matching with any dictionary image (not illustrated) stored in advance.

The presentation information generation unit 14 has a function to generate and output presentation information as a combination of a content associated with a recognized object in advance and guide information that prompts a user to perform a positioning operation for adjusting the positional relation between the content and the object.

The content information database (DB) 15 stores information of a content associated with an object in advance.

The guide information generation unit 16 has a function to generate and output guide information that assists positioning between a content and an object. The guide information generation unit 16 includes an adjustment amount calculation unit 161, a learning unit 162, and a grasped state database (DB) 163.

The adjustment amount calculation unit 161, as an adjustment amount calculation unit, has a function to calculate an adjustment amount to be included in guide information. The adjustment amount is a physical quantity related to a positioning operation of the display device 20 and is expressed in, for example, angle, distance, or orientation. The adjustment amount calculation unit 161 has a function to calculate an adjustment amount to be presented for positioning based on an element such as the value (for example, grasped angle) of the supported state of the display device 20, which is calculated by the grasped state calculation unit 12, the distance between an object and the display device 20, information of an appropriate positional relation between a content and an object (for example, information (such as height) of a particular part of the object associated with the content), the tendency of a positioning operation (for example, angle adjustment amount) by a user in response to guide information, or the tendency of the supported state (for example, grasped angle) for each object or each presentation information.

The learning unit 162 learns the tendency of a positioning operation of the display device 20 or an adjustment operation of the supported state by a user.

The grasped state DB 163 stores data (hereinafter referred to as “record data”) related to a positioning operation of the display device 20 by a user. According to the embodiment, record data is accumulation of information indicating a positioning operation actually performed by a user in response to presentation information output in advance. Record data can be used for learning of the tendency of an operation or a supported state for each object or each content.

The transmission-reception unit 17 includes, for example, a Bluetooth interface and has a function to enable data transmission to and reception from the display device 20 through pairing. The transmission-reception unit 17 and the transmission-reception unit 24 may be connected to each other by another wireless or wired connection scheme.

Note that the information processing terminal 10 and the display device 20 may be configured as separate devices as described above or may be configured as an integrated device. The transmission-reception unit 17 and the transmission-reception unit 24 may be integrally configured.

FIG. 2 illustrates an exemplary hardware configuration of the information processing terminal 10 as a positioning assistance device according to the embodiment. The information processing terminal 10 includes a control unit 101, a storage unit 102, a communication interface (I/F) 103, an input unit 104, an output unit 105, and a battery 106.

The control unit 101 includes a central processing unit (CPU) 1011, a read only memory (ROM) 1012, and a random access memory (RAM) 1013 and controls each component. The control unit 101 can execute the above-described various functions of the information processing terminal 10 when the CPU 1011 loads a program stored in the ROM 1012 or the storage unit 102 onto the RAM 1013 and executes the program.

The storage unit 102 is an auxiliary storage device such as a hard disk drive (HDD), a solid-state drive (SSD), or a semiconductor memory (for example, flash memory) and non-transitorily stores, for example, the program executed by the control unit 101 and setting data necessary for executing the program.

The communication interface 103 is an interface for wireless or wired communication. The communication interface 103 includes, for example, a Bluetooth interface as described above and enables data transmission to and from the display device 20.

The input unit 104 is, for example, a touch screen, a keyboard, or a mouse and receives input from a user. The output unit 105 is, for example, a display or a speaker.

The battery 106 supplies electric power to each component of the information processing terminal 10.

### Operation

The following describes operation of the positioning assistance system 1 including the information processing terminal 10 and the display device 20 configured as described above.

### 1) Overview

First, an overview of the operation of the positioning system 1 described below will be described below.

FIG. 3 illustrates an exemplary relation between the range of image capturing by the image capturing unit 21 of the display device 20 and the range of observation through the video display unit 23. A user US grasps the display device 20 and observes the object OB through the video display unit 23 by holding the display device 20 over an object OB in a reality space. In this diagram, the user US grasps the display device at a grasped angle θ_{c} resulting from movement through substantially circular motion about the shoulders from a horizontal reference position RP.

As illustrated in a word balloon at an upper part of FIG. 3, a content CTS associated with the recognized object OB in advance is displayed on a display screen 23D provided by the video display unit 23. Accordingly, the user US can experience an augmented reality in which the content CTS is superimposed and displayed in a reality space including the object OB on the display screen 23D.

In the example illustrated in FIG. 3, the content CTS includes text information “the top is located at 500 m”, and indicates that the height of a top part OBT of the object OB is 500 m. The display screen 23D illustrated with a solid line is a range of actual observation by the user US, and a dashed line 21V illustrates a range subjected to image capturing by the image capturing unit 21. In this manner, a view angle ρ of the image capturing unit 21 and a view angle ϕ through the video display unit 23 do not necessarily match each other, and accordingly, the range 23D of observation by the user US and the range 21V of video data obtained through image capturing by the image capturing unit 21 do not necessarily match each other. Since the content CTS is presented based on the video data obtained through image capturing by the image capturing unit 21, the positional relation between the object OB observed through the video display unit 23 and the content CTS is potentially shifted from a positional relation set by the provider of the content CTS. In this example, the content CTS of “the top is located at 500 m” is desirably displayed near the top part OBT of the object OB (or superimposed on the top part OBT) on the display screen 23D, but the top part OBT is not observed in the observation range of the user US (the display screen 23D). Thus, a positioning operation to position the top part OBT in the observation range of the user US (the display screen 23D) is needed to achieve the positional relation intended by the content provider.

According to the embodiment, when the user US grasps the display device 20 and performs observation, guide information is presented that prompts the user to perform such a positioning operation that the positional relation between an object and an AR content becomes a relation set by a content provider. For this, an adjustment amount related to a necessary positioning operation is calculated with taken into consideration the tendency of a positioning operation by the user. The information processing terminal 10 according to the embodiment determines the tendency of an operation by the user by using both or one of “record data of a positioning operation by the user in response to presented guide information” and “record data of a positioning operation by one or more users in response to guide information of a specified object”, which are acquired in advance, and corrects the value of guide information to be actually presented in accordance with the tendency.

In other words, the information processing terminal 10 estimates the range of gaze by a user based on the distance between an object and the device and the grasped angle of the display device, and outputs guide information for adjusting to a more accurate grasped angle when the user gazes a range different from that of presentation information. For this, calibration is performed on the amount of an actual positioning operation in response to guide information when the user starts using the device, and subsequent guide information is corrected for the user. Additionally or alternatively, the information processing terminal 10 learns the tendency of the supported state for each object or each presentation information and corrects, for the object or the presentation information, guide information to be presented to the user by using a result of the learning.

Note that the following description will be made on, as an example, adjustment of the grasped angle of the display device 20 in the vertical direction, in particular, but the application range of the embodiment is not limited to the grasped angle in the vertical direction. The device or system according to the embodiment may present, for example, guide information of the grasped angle in the horizontal direction or the distance to an object.

In the following description, the display device 20 includes a transparent display but is not limited thereto, and may be of an optical transmissive type or a video transmissive type with which a user can transparently observe a reality space.

The information processing terminal 10 provides guide information for grasped angle adjustment, as information that assists positioning by a user, based on the distance between an object and the display device 20 at image capturing, the angle at which the display device 20 is grasped by the user, the height of a particular part of the object referred to by a content (in other words, particular part of the object specified in advance in association with an appropriate positional relation between the content and the object), or a target grasped angle. Accordingly, the information processing terminal 10 guides tilting of the display device 20 to a target angle.

Guide information appropriate for a user is generated and output with consideration that the magnitude of actual angle correction in response to guide information for adjustment of the grasped angle of the display device 20 potentially differs among users. Specifically, this is achieved by two schemes below.

(A) When a user starts using the display device 20, guide information of the grasped angle is presented to the user, calibration is performed based on the angle of actual adjustment by the user in response to the guide information, and guide information to be presented to the user during object observation is corrected for the user

(B) The angle of grasping by each of one or more users for each object and each presentation information is sequentially learned, and guide information to be presented to a user is determined for each object or each presentation information based on a result of the learning

Note that premises condition in this example are as follows:
AR expression is performed by a display device with a camera of a low frame rate (for example, 1 fps) and no memory nor processor mounted;
An object can be recognized based on video data;
The range of view through the display terminal does not necessarily matches the entire view angle of the camera; and
A user observes the object through a display.

FIG. 4 is a diagram for description of definitions of symbols or reference signs to be used below before description of operation of the positioning assistance system 1.

In FIG. 4, similarly to FIG. 3, the user US grasps and holds the display device 20 over the object OB. In this example, similarly to FIG. 3, a displayed content (not illustrated) refers to the top OBT of the object OB. Note that guide information that prompts a user to perform a positioning operation is displayed on the display screen 23D provided by the video display unit 23. In this example, the guide information includes a text GIT “tilt upward by θₐ degrees” and an arrow image GIA. Note that 23B denotes an opaque part in which, for example, the battery of the display device 20 is housed.
d: Distance between an object and the display device
h: Height of a particular part (in this example, the top OBT) of the object referred to by a content
θ_{c}: Grasped angle (relative to the reference position RP on a horizontal plane) at which the user holds the display device over the object
θₜ: Target grasped angle after correction (calculated by using d and h) (TP denotes a target position of the display device)
θₐ: Grasped angle adjustment amount presented to the user (calculated by using θ_{c} and θₜ) (not illustrated)

### 2) Processing Process

FIG. 5 illustrates an exemplary processing process of presentation of a content related to an object, generation of guide information, and grasped angle adjustment.

First at step S101, the image capturing unit 21 of the display device 20 generates video data through image capturing of the object. In addition, the acceleration measurement unit 22 measures acceleration applied to the display device 20 in the vertical direction and generates acceleration data. The video data and the acceleration data are each transmitted to the information processing terminal 10 through the transmission-reception unit 24 at an optional timing (for example, per second). The video data and the acceleration data may be transmitted at transmission intervals different from each other.

At step S102, the video acquisition unit 11 of the information processing terminal 10 acquires the video data, and the grasped state calculation unit 12 acquires the acceleration data.

At step S103, the image recognition unit 13 recognizes the object in the video data based on, for example, a dictionary image for image recognition.

At step S104, the guide information generation unit 16 calculates the object-display device distance d. The guide information generation unit 16 can calculate the distance d from, for example, a size ratio of the dictionary image for image recognition and the object recognized in the video data.

At step S105, the grasped state calculation unit 12 calculates the grasped angle θ_{c} of the display device 20 based on the acceleration of the display device 20 and gravitational acceleration. The grasped angle θ_{c} may be calculated by using a typically known method for calculation of a tilt angle from a measured value of the acceleration sensor. As described above, the present invention is not limited to the grasped angle in the vertical direction but another physical quantity related to the supported state may be calculated.

At step S106, the adjustment amount calculation unit 161 calculates an adjustment amount related to a positioning operation for setting an appropriate positional relation between the content and the object and generates guide information. Specifically, the adjustment amount calculation unit 161 calculates the adjustment amount based on record data of a positioning operation performed by a user in response to presentation information output in advance. According to the embodiment, the adjustment amount calculation unit 161 generates guide information by using the tendency of a target grasped angle obtained for each object or each presentation information by past learning, and/or a calculation model optimized based on a calibration result. Specific adjustment amount calculation, learning, and calibration methods will be described later. The guide information includes the calculated adjustment amount. According to the embodiment, the guide information includes an arrow image and text information in accordance with the magnitude of the adjustment amount.

At step S107, the presentation information generation unit 14 generates presentation information as a combination of the content related to the object and the guide information. The presentation information is transmitted through the transmission-reception unit 17 and received by the display device 20 through the transmission-reception unit 24.

At step S108, the display device 20 presents the received presentation information to the user through the video display unit 23. Exemplary display of the presentation information will be described below with reference to FIGS. 6A and 6B.

FIG. 6A illustrates exemplary display of conventional presentation information. A range CV of image capturing by an image capturing unit and a display screen DV of a video display unit do not match each other. The content CTS includes text information “the top is located at 500 m” and refers to the top part OBT of the object OB, but the positions of the content CTS and the top part OBT on the display screen DV is shifted from a positional relation intended by a content provider. In a conventional technology, subsequent positioning depends on the user, and the grasped angle needs to be adjusted based on determination by the user.

FIG. 6B illustrates an example in which presentation information according to the embodiment is displayed on the display screen 23D provided by the video display unit 23. In FIG. 6B as well, the range 21V of image capturing by the image capturing unit 21 and the range of observation through the display screen 23D do not match each other. As illustrated on the left side in FIG. 6B, presentation information generated by the presentation information generation unit 14 is displayed on the display screen 23D. The presentation information includes the upward arrow image GIA and text information GIT “tilt upward by 15°”, as guide information, in addition to the content CTS same as that in the example of FIG. 6A. The information “upward by 15°” corresponds to an adjustment amount calculated by the adjustment amount calculation unit 161. The arrow image GIA may be generated to have a length and an orientation on which the adjustment amount is reflected.

When having checked the presentation information displayed on the display screen 23D, the user performs a positioning operation to “tilt upward by 15°” (adjustment of the angle at which the display device 20 is grasped). When not knowing accurate “15°”, the user can rely on the length of the displayed arrow image GIA to perform adjustment instructed by the text information GIT. Accordingly, as illustrated on the right side in FIG. 6B, the position of the top part OBT of the object OB transparently observed on the display screen 23D changes, and the content CTS is displayed in an appropriate positional relation corresponding to its reference.

Then at step S109, the display device 20 measures, by using the acceleration measurement unit 22, acceleration applied to the display device 20 in the vertical direction after display of the presentation information (guide information), and transmits a result of the measurement to the information processing terminal 10 through the transmission-reception unit 24.

At step S110, the grasped state calculation unit 12 of the information processing terminal 10 acquires acceleration data after output of the presentation information.

At step S111, the grasped state calculation unit 12 calculates, based on the acquired acceleration data and gravitational acceleration, a grasped angle θ’ₜ of the display device 20 after the positioning operation. For example, when a constant time has elapsed since the presentation information is transmitted to the display device 20, the grasped state calculation unit 12 estimates that the positioning operation is performed, and calculates the grasped angle θ’ₜ after the positioning operation. Alternatively, the grasped state calculation unit 12 may determine, based on change of the acceleration data, that the positioning operation is performed.

At step S112, the guide information generation unit 16 registers the grasped angle θ’ₜ after the positioning operation and the distance d to the grasped state DB 163 as record data, performs learning by using the record data accumulated in the grasped state DB 163, and updates a calculation model to be used by the adjustment amount calculation unit 161.

FIG. 7 illustrates exemplary record data stored in the grasped state DB. The record data includes, for example, an object ID, presentation information, the height of a particular part of an object referred to by the presentation information, image capturing distance, and the grasped angle (actual value) of the display device 20. Note that the record data illustrated in FIG. 7 assumes, as a premise, a situation in which a miniature model of a tower of a height 333 m is exhibited at an exhibition site and presentation information including a content “the top of the tower is located at 333 m” prepared in advance is displayed on the display screen 23D when the user holds the display device 20 over the miniature model. Assume that “the top of the tower” referred to by the presentation information is located at the height of 2.0 m in the miniature model. In other words, the provider of the content expects that the user observes the above-described content over “the top of the tower” (at the height of 2.0 m).

In FIG. 7, the object ID is a sign that identifies an object recognized by the image recognition unit 13, the presentation information is text information “the top of the tower is located at 333 m” included in the content, the height of a particular part of the object referred to by the presentation information is the height of 2.0 m at the miniature model, and the angle at which the display device 20 is grasped by the user after adjustment is 15 ° (actual value).

However, the positioning assistance system 1 is not limited to the above-described example but is also applicable to a case of holding over an exhibited object at a museum, an exhibition, or the like as well as a case of holding over a building or the like outdoor.

### 3) Calibration Process

FIG. 8 illustrates an exemplary process of calibration processing.

First at step S201, the guide information generation unit 16 of the information processing terminal 10 generates guide information using a calibration adjustment amount (also referred to as “correction adjustment amount”) θ’ₐ. The calibration adjustment amount θ’ₐ may be a fixed value or may be variable in accordance with a situation (for example, may be changed for each user). The guide information is generated as the arrow image GIA and/or the text GIT as exemplarily illustrated in FIG. 4. A necessary adjustment amount and a necessary adjustment direction can be each expressed in the length and orientation of an arrow image.

Subsequently at step S202, the presentation information generation unit 14 generates calibration presentation information to be presented to the user based on the guide information. The presentation information is received by the display device 20 through the transmission-reception units 17 and 24.

At step S203, the video display unit 23 displays the calibration presentation information transmitted from the information processing terminal 10.

At step S204, the acceleration measurement unit 22 measures acceleration in the vertical direction after grasped angle adjustment is performed by the user in accordance with the display of the calibration presentation information. Acceleration data is transmitted to the information processing terminal 10 by the transmission-reception unit 24.

At step S205, the grasped state calculation unit 12 acquires the acceleration data.

At step S206, the grasped state calculation unit 12 calculates, by using the acceleration data transmitted from the display device 20 and gravitational acceleration, an amount θ’_{c} of grasped angle adjustment performed by the user in response to the calibration presentation information. Exemplary calculation of the adjustment amount θ’_{c} will be described later.

At step S207, the guide information generation unit 16 corrects, based on the amount θ’_{c} of grasped angle adjustment performed by the user, a calculation model to be used by the adjustment amount calculation unit 161.

### 4) Exemplary Calculation of Adjustment Amount

The adjustment amount calculation unit 161 can calculate a target grasped angle θₜ by, for example, Expression (1).

$${θ}_{t} = {tan}^{- 1} \frac{h}{d}$$

As described above,
d: Distance between an object and the display device
h: Height of a particular part of the object referred to by a content
θ_{c}: Grasped angle at which the user holds the display device over the object
θₜ: Target grasped angle after correction (calculated by using d and h)
θₐ: Grasped angle adjustment amount presented to the user (calculated by using θ_{c} and θₜ)

In addition, the adjustment amount calculation unit 161 can calculate an adjustment amount θₐ presented to the user by, for example, Expression (2) using the target grasped angle θₜ.

$${θ}_{a} = {θ}_{t} - {θ}_{c}$$

### 5) Exemplary Calculation of Calibration Adjustment Amount

When a user starts using the display device 20, the adjustment amount calculation unit 161 can perform calibration take into consideration the tendency of an operation by the user.

As described above for the adjustment amount calculation, the information processing terminal 10 first generates calibration guide information including the calibration adjustment amount θ’ₐ under control of the guide information generation unit 16. Presentation information including the guide information is transmitted to the display device 20 and presented to the user through the video display unit 23. Then, the information processing terminal 10 calculates, based on the acceleration of the display device 20 after the presentation, the amount θ’_{c} of adjustment actually performed by the user in response to the calibration adjustment amount θ’ₐ and calculates a constant α by, for example, Expression (3). The calculated α is stored in a non-illustrated storage unit.

$$α = \frac{{{θ}^{′}}_{a}}{{{θ}^{′}}_{c}}$$

θ’ₐ: Calibration adjustment amount
O′_{c}: The amount of adjustment performed by the user in response to θ’ₐ
α: Constant

Thereafter, when the display device 20 is used by the user, the adjustment amount calculation unit 161 extends, for example, Expression (2) to Expression (2′) below by using the stored constant α and calculates the adjustment amount θₐ.

$${θ}_{a} = α \left({θ}_{t} - {θ}_{c}\right)$$

The adjustment amount θₐ calculated by Expression (2′) is corrected with taken into consideration the tendency of an operation by the user and thus can prompt the user to perform an appropriate positioning operation.

### 6) Learning Method (Example 1)

In a first exemplary method of learning by the learning unit 162, learning can be performed to optimize weight coefficients W₀, W₁, and W₂ by using the grasped angle θ’t of the display device 20, the object-display device distance d, and the height h of a particular part of an object after a positioning operation, which are included in record data, as indicated in Expression (4). The learning unit 162 can store a learning-completed model in a non-illustrated storage unit and update the model at each learning.

$${{θ}^{′}}_{t} = {w}_{o} + {w}_{1} d + w {}_{2} h$$

In a case of guide information generation, the adjustment amount calculation unit 161 reads the latest learning-completed model from the storage unit and determines, by using the distance d between an object to be observed and a portable display device and the height h of a particular part of the object, the target grasped angle θₜ after adjustment when guide information for grasped angle adjustment is presented to a user.

The learning by the learning unit 162 can be sequentially performed each time the user performs observation. For example, a Bayesian linear regression method can be used as a method of sequentially performing learning and optimizing weight coefficients.

### 7) Learning Method (Example 2)

A Gauss function of Expression (5) can be used as a second exemplary method of learning by the learning unit 162. In this example, the learning unit 162 performs learning to optimize constants A, µ, and σ by assuming that the grasped angle θ’ₜ of the display device 20 in observation by the user for each object or each content, which is included in record data, obeys the Gauss function of Expression (5).

$$y = A exp \left\{- \frac{{\left(x - μ\right)}^{2}}{2 {o}^{2}}\right\}$$

In a case of guide information generation, the adjustment amount calculation unit 161 determines a grasped angle x of the display device 20, which maximizes y (for example, the number of users having performed observation at the grasped angle x) in Expression (5), as the target grasped angle (target value) θt after adjustment when guide information for grasped angle adjustment is presented to the user. Note that a certain amount of data or more is accumulated in the grasped state DB 163 in advance.

For example, a least-square method can be used as a method by which the learning unit 162 performs learning by using data accumulated in the grasped state DB 163 and optimizes the constants A, µ, and σ.

### Effects

As described above in detail, according to the embodiment of the present invention, in the positioning assistance system 1 including the display device 20 and the information processing terminal 10, when a user performs observation by holding the display device 20 over the object OB, guide information is presented to the user so that the positional relation between the content CTS displayed on the video display unit 23 of the display device 20 and the object OB transparently observed through the video display unit 23 becomes a relation set by the content provider. In this case, the information processing terminal 10 corrects the value of the guide information by using at least one of the distance between the object and the display device, the angle at which the display device is grasped by the user, the height of a place referred to by presentation information, and a target grasped angle. In other words, the information processing terminal 10 can generate corrected guide information based on the tendency of an operation by the user by performing the above-described calibration based on record data acquired in advance, or based on the tendency of an operation on the object or the content by performing the above-described learning.

Accordingly, in AR content presentation using the display device 20, more appropriately corrected guide information can be presented to a user to prompt positioning for setting an appropriate positional relation between an object and a content, thereby guiding a more accurate operation. Moreover, the tendency of an operation by each user and the tendency of an operation in accordance with an object or a content are both considered through calibration and learning, and thus a further accurate operation is expected.

FIGS. 9A and 9B illustrate exemplary corrected guide information. FIGS. 9A and 9B each assume a case in which an angle to be actually tilted is 30°, FIG. 9A illustrating exemplary guide information presented to a user US11 who tends to perform larger adjustment than instructed, FIG. 9B illustrating exemplary guide information presented to a user US12 who tends to perform smaller adjustment than instructed.

In FIG. 9A, an arrow IDA11 and an instruction IDT11 “tilt upward by 15°”, which are related to the object OB, are displayed in a display screen 23D11 for the user US11. Reference sign 23B11 denotes a part in which a battery or the like is stored.

In FIG. 9B, an arrow IDA12 larger than IDA11 in FIG. 9A and an instruction IDT12 “tilt upward by 45°”, which are related to the object OB, are displayed in a display screen 23D12 for the user US12. Reference sign 23B12 denotes a part in which a battery or the like is stored.

In this manner, when an angle to be actually tilted is 30°, this adjustment amount (15° in FIG. 9A or 45° in FIG. 9B) to be presented is corrected in accordance with the tendency of an operation by a user so that more accurate positioning can be achieved along with expectation by a content provider.

### Other Embodiments

Note that the present invention is not limited to the above-described embodiment. For example, the above description below is made on the example of generation of guide information that prompts adjustment of the angle at which a user grasps the display device 20, but the present invention is not limited to angle adjustment in the vertical direction as described above, and adjustment at another viewpoint may be prompted, such as angle adjustment in the horizontal direction or adjustment of the distance between an object and the display device.

The above-described embodiment is mainly described for a method of observation by optical transmission through a transparent display, but is not limited thereto and is also applicable to a method of transparent observation by video transmission (such as display of a camera video on a display).

Functional components included in the display device 20 or the information processing terminal 10 may be distributed to a plurality of devices so that these devices perform processing in cooperation with each other. Each functional component may be achieved by using a circuit. The circuit may be a dedicated circuit that achieves a particular function or may be a general-purpose circuit such as a processor.

Each above-described processing process is not limited to the described procedure but some steps may be performed in an interchanged order or may be simultaneously performed in parallel. The above-described series of processing do not necessarily need to be temporally continuously executed but each step may be executed at an optional timing.

Each above-described method may be stored in a recording medium (storage medium), for example, a magnetic disk (such as floppy (registered trademark) disk or hard disk), an optical disk (such as CD-ROM, DVD, or MO), or a semiconductor memory (such as ROM, RAM, or flash memory), as a program (software means) that can be executed by a calculator (computer), or may be transmitted through a communication medium, and then may be distributed. Note that programs stored in a medium include a setting program that configures, in a calculator, software means (including not only an execution program but also a table and a data structure) to be executed by the calculator. A calculator that achieves an above-described device reads a program recorded in a recording medium, establishes software means by a setting program in some cases, and executes above-described processing with operation controlled by the software means. Note that a recording medium in the present specification is not limited to a distribution recording medium but also is a storage medium such as a magnetic disk or a semiconductor memory, which is provided inside a calculator or an instrument connected through a network.

The present invention is not limited to the above-described embodiments but may be modified in various manners at execution without departing from the scope thereof. The embodiments may be combined as appropriate, and in this case, combined effects can be obtained. Moreover, the above-described embodiments include various kinds of inventions, and the various kinds of inventions can be extracted with combinations of those selected from among a plurality of disclosed components. For example, when a problem can be solved and effects can be obtained despite of deletion of some components indicated in the embodiments, a configuration in which the components are deleted is extracted as an invention.

Reference Signs List

| | |
|---|---|
| 1 | positioning assistance system |
| 10 | information processing terminal |
| 11 | video acquisition unit |
| 12 | grasped state calculation unit |
| 13 | image recognition unit |
| 14 | presentation information generation unit |
| 15 | content information database |
| 16 | guide information generation unit |
| 161 | adjustment amount calculation unit |
| 162 | learning unit |
| 163 | grasped state database |
| 17 | transmission-reception unit |
| 20 | display device |
| 21 | image capturing unit |
| 22 | acceleration measurement unit |
| 23 | video display unit |
| 24 | transmission-reception unit |

1. A positioning assistance device that assists positioning between a content displayed on a display and an object transparently observed through the display, the positioning assistance device comprising:
a processor; and
a storage medium having computer program instructions stored thereon, when executed by the processor, perform to:
calculate a supported state of the display relative to the object;
calculate, for the supported state, an adjustment amount related to a positioning operation for setting an appropriate positional relation between the content and the object; and
generate and output presentation information including the adjustment amount, and
calculates the adjustment amount by using record data of a positioning operation performed by a user of the display in response to the presentation information output in advance.

2. The positioning assistance device according to claim 1, wherein the computer program instructions further perform to calculates the adjustment amount by using at least one of
a correction coefficient calculated based on the record data obtained from a particular user, or
a model subjected to learning based on the record data obtained from one or more users for each content or each object.

3. The positioning assistance device according to claim 1 , wherein the computer program instructions further perform to calculates the adjustment amount by using at least one of a distance between the object and the display, a current supported state of the display, a height of a particular part of the object specified in advance in accordance with an appropriate positional relation between the content and the object, or a target supported state of the display for the appropriate positional relation.

4. The positioning assistance device according to claim 1, wherein the computer program instructions
calculate a correction coefficient based on the record data including a correction adjustment amount presented to the user in advance and a record adjustment amount performed by the user for the correction adjustment amount, calculate a target value representing a supported state of the display for an appropriate positional relation between the content and the object, and calculate the adjustment amount by multiplying the difference between a value representing a current supported state of the display and the target value by the correction coefficient.

5. The positioning assistance device according to claim 1 , wherein the computer program instructions further perform subject a model to learning for each content or each object based on the record data obtained from one or more users, the model having explanatory variables and an objective variable, the explanatory variables being a height of a particular part of the object specified in advance in accordance with an appropriate positional relation between the content and the object and a distance between the object and the display, the objective variable being a support angle of the display after the presentation information is output, and
calculates the adjustment amount by using, as a target support angle, an output value obtained by inputting the height of the particular part of the object and the distance between the object and the display to the model subjected to learning by the first learning unit.

6. The positioning assistance device according to claim 1 , wherein the computer program instructions further perform optimize each constant of a Gauss function y = f(x) based on the record data obtained from one or more users, where x represents a support angle of the display after elapse of a predetermined time since the presentation information is output, and y represents the number of users included in the record data, and
calculates the adjustment amount by using, as a target support angle, x that maximizes y in the Gauss function optimized by the second learning unit.

7. A positioning assistance method of assisting positioning between a content displayed on a display and an object transparently
observed through the display, the positioning assistance method comprising:
calculating a supported state of the display relative to the object; calculating, for the supported state, an adjustment amount related to a positioning operation for setting an appropriate positional relation between the content and the object; and
generating and outputting presentation information including the adjustment amount, wherein
the adjustment amount is calculated by using record data of a positioning operation performed by a user of the display in response to the presentation information output in advance.

8. A non-transitory computer-readable medium having computer-executable instructions that, upon execution of the instructions by a processor of a computer, cause the computer to function as the positioning assistance device according to claim 1 .
